(19) United States
(12) Patent Application Publication
(10) Pub. No.: US 2026/0287079 A1
(43) Pub. Date: Sep. 24, 2026

(54) FLUID-DISPENSING MOTORIZED VALVE AND ASSOCIATED MANUFACTURING METHOD

(71) Applicant: VERNET, Ollainville (FR)

(72) Inventors: Guillaume Julien Gautier Graindorge, Montigny Le Bretonneux (FR); Thierry Maraux, Les Clayes Sous Bois (FR)

(21) Appl. No.: 19/156,999

(22) PCT Filed: Feb. 26, 2024
(86) PCT No.: PCT/EP2024/054753

§ 371 Date: Aug. 15, 2025

(30) Foreign Application Priority Data
Feb. 27, 2023 (FR) FR2301794

(51) Int. Cl. F16K 27/06; F01P 7/14; F16K 11/087; F16K 31/04; F16K 31/53; F16K 37/00

(52) U.S. Cl. CPC F16K 27/067; F16K 11/0873; F16K 31/041; F16K 31/535; F16K 37/0091; F01P 7/14; F01P 2007/146

(57) ABSTRACT

This valve includes a housing, which includes a body made of molded plastic and defining an internal volume connected to the outside of the housing by an inlet and outlets. An electric pump, arranged in a first sub-volume, is provided with an intake opening into the inlet and a discharge opening into a passage connecting the first sub-volume to a second sub-volume by opening into it along a passage axis. A shutter is arranged in the second sub-volume in a manner that can be moved by an electromechanical actuating device to control the opening and closing of the outlets. The body defines an opening, through which the second sub-volume is directly connected to the outside of the body.

### FIELD OF THE DISCLOSURE

The present invention relates to a fluid-dispensing motorized valve. It also relates to a method for manufacturing such a valve.

### BACKGROUND

In practice, the pump and the valve are separate from each other, the physical spacing between them having the advantage, among others, of limiting the design and manufacturing constraints specific to each of them in the sense that they do not have common components. However, it is necessary to fluidically connect the valve and the pump, typically by hoses, notably a hose connecting the pump discharge to the valve inlet. This results in significant bulk and therefore considerable weight, with associated costs, as well as risks of leakage and pressure losses at the hoses.

### SUMMARY

The invention particularly relates to valves for fluid circulation circuits, notably cooling fluid, embedded in vehicles with thermal, electric, hydrogen, or hybrid engines. Such a valve includes a shutter, which is mounted to move, for example, in rotation around an axis, in a valve housing to regulate a fluid flow through the housing between an inlet and outlets of the housing, this shutter being driven in movement by an electromechanical actuation device, integrated into the valve. The fluid flows through the valve by means of its drive in the circulation circuit to which the valve belongs, under the effect of a pump, typically electric.

The aim of the present invention is to propose a new motorized valve, which, while being practical to manufacture, is more compact and more efficient.

To this end, the invention relates to a fluid-dispensing motorized valve, as defined in claim 1.

The invention also relates to a method for manufacturing a valve as defined above, this method being as defined in claim 10.

One of the ideas behind the invention is to integrate a fluid drive pump into the valve, to form a module with a single housing whose body is molded plastic, while cleverly managing the issue related to the molding-demolding constraints of the housing body. To do this, the internal volume of the valve housing body according to the invention, wherein the fluid is intended to flow between an inlet and at least two outlets of the housing, is subdivided into two sub-volumes that are directly connected to each other by a passage defined by the housing body: the pump is mounted in the first sub-volume to suck the fluid at the housing inlet and discharge the fluid into the aforementioned passage, while the shutter is movably mounted in the second sub-volume to send the fluid from the aforementioned passage to one or more of the at least two outlets, thus controlling these in opening and closing. The aforementioned passage avoids the need for a hose, eliminating leakage risks, reducing pressure loss, and saving weight, compactness, and assembly time. The invention also provides for equipping the valve with a dedicated member at an opening of the housing body, formed by molding-demolding of this body. This opening typically results from the use of a molding core during the manufacture of the housing body by molding, this molding core being necessary for the formation of the aforementioned passage, as explained in more detail below. After demolding the housing body, this opening is aligned with the aforementioned passage along an axis along which the passage opens into the second sub-volume of the internal volume of the body. The invention takes advantage of this opening, whose presence is imposed by the necessities of molding-demolding of the housing body, by placing the aforementioned dedicated member there and allowing this dedicated member to be chosen from several possible members, namely one or more sealing members, in particular an instrumented sealing member and a non-instrumented sealing member, and one or more flow members, in particular an added flow member and a flow member molded with the housing body. It is thus possible to select the dedicated member that actually belongs to the valve manufactured according to the invention and thus integrate into this valve a functionality chosen from several possibilities, without having to review the specifics of the manufacture of the housing body by molding, in particular without having to change the mold used to manufacture this body. The valve according to the invention thus combines performance and adaptability, and can be modified or upgraded with regard to its dedicated member at the aforementioned opening of the housing body. Moreover, certain aspects of the dedicated member, possibly of the sealing and flow members among which this dedicated member is chosen, can advantageously be provided to gain even more practicality, as detailed below.

Additional advantageous features of the valve and/or the method according to the invention, are defined in the other claims.

### BRIEF DESCRIPTION OF THE DRAWINGS

The invention will be better understood from the following description, given solely by way of example and referring to the drawings wherein:

FIG. 1 is a perspective view of a valve according to the invention;

FIG. 2 is a perspective view of a part of the valve, according to arrow Il of FIG. 1;

FIG. 3 is a section along plane III of FIG. 1;

FIG. 4 is a section along line IV-IV of FIG. 3, after removal of a valve cover;

FIG. 5 is an elevation view according to arrow V of FIG. 4;

FIG. 6 is a section in the plane of FIG. 3, showing only a part of a valve housing;

FIGS. 7 and 8 are views respectively similar to FIGS. 2 and 3, illustrating a modification made to the valve of FIGS. 1 to 5;

FIGS. 9 and 10 are views respectively similar to FIGS. 7 and 8, illustrating another modification made to the valve of FIGS. 1 to 5; and

FIGS. 11 and 12 are views respectively similar to FIGS. 7 and 8, illustrating yet another modification made to the valve of FIGS. 1 to 5.

### DETAILED DESCRIPTION

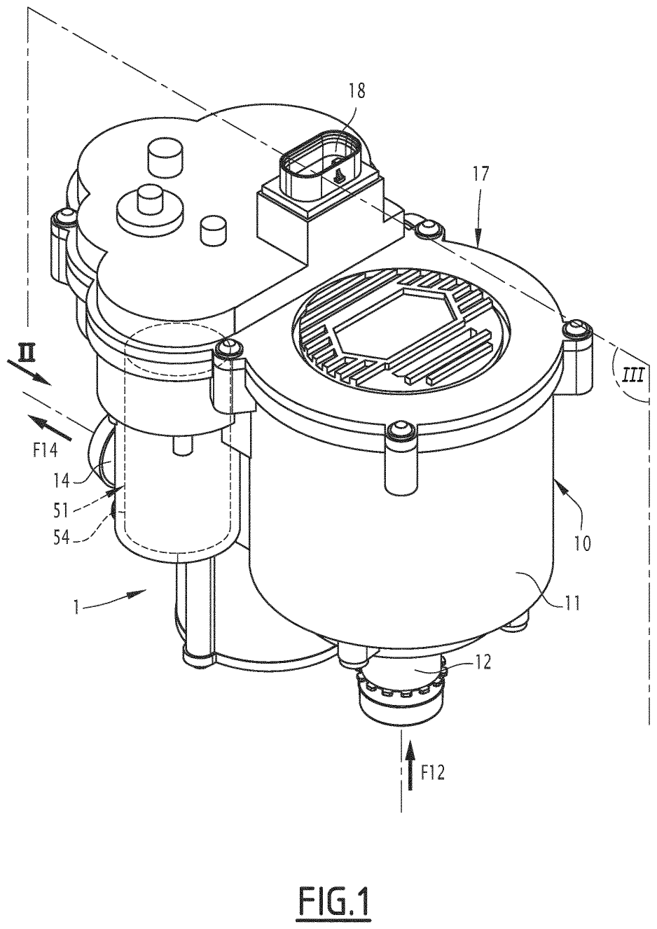

In FIGS. 1 to 5, a fluid-dispensing motorized valve, referenced 1, is shown. This valve 1 is suitable for integration into a fluid circulation circuit, notably a cooling fluid. The valve 1 is, for example, used in a cooling circuit of a vehicle engine, this engine being thermal, electric, hydrogen, or hybrid.

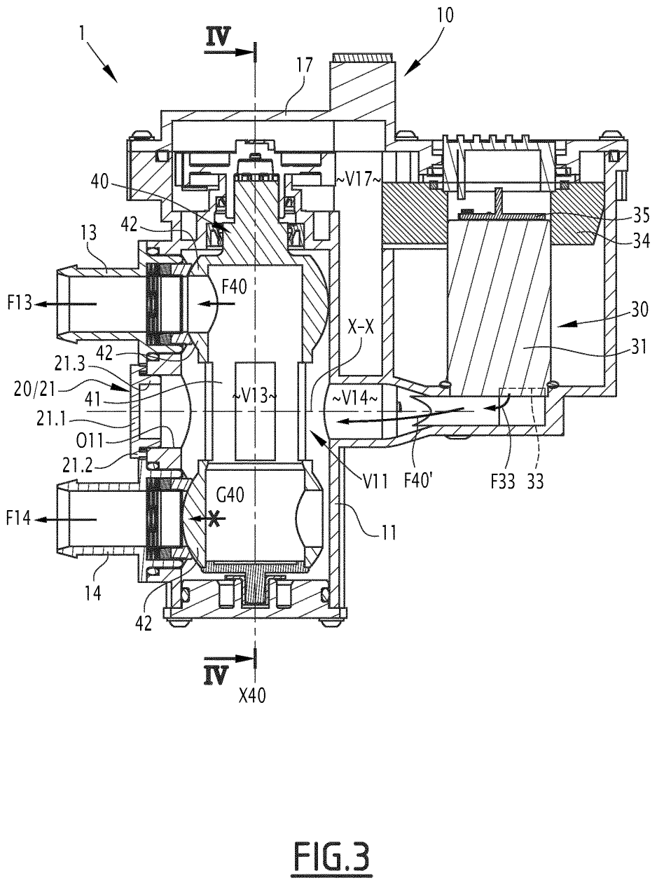

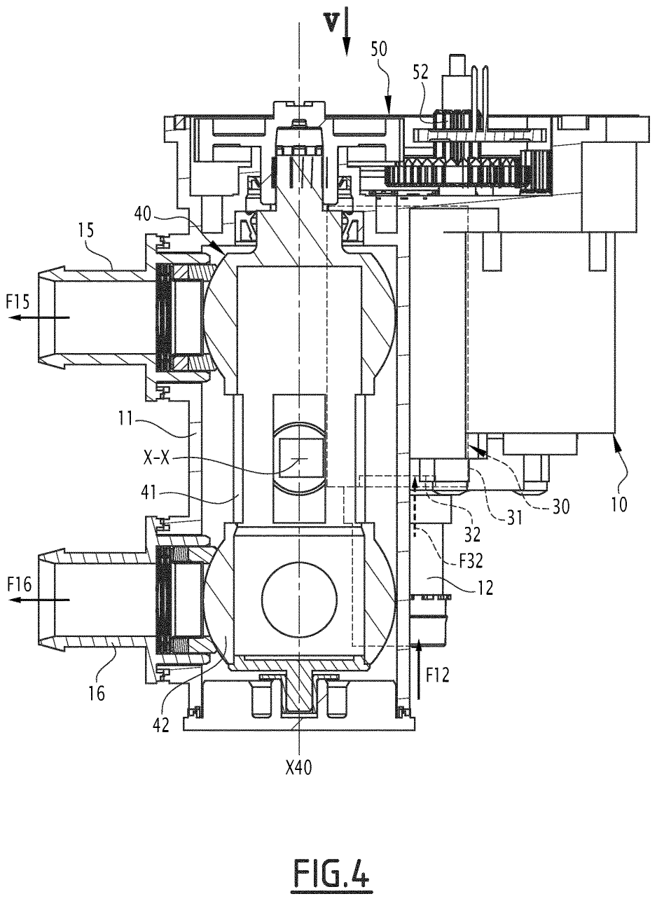

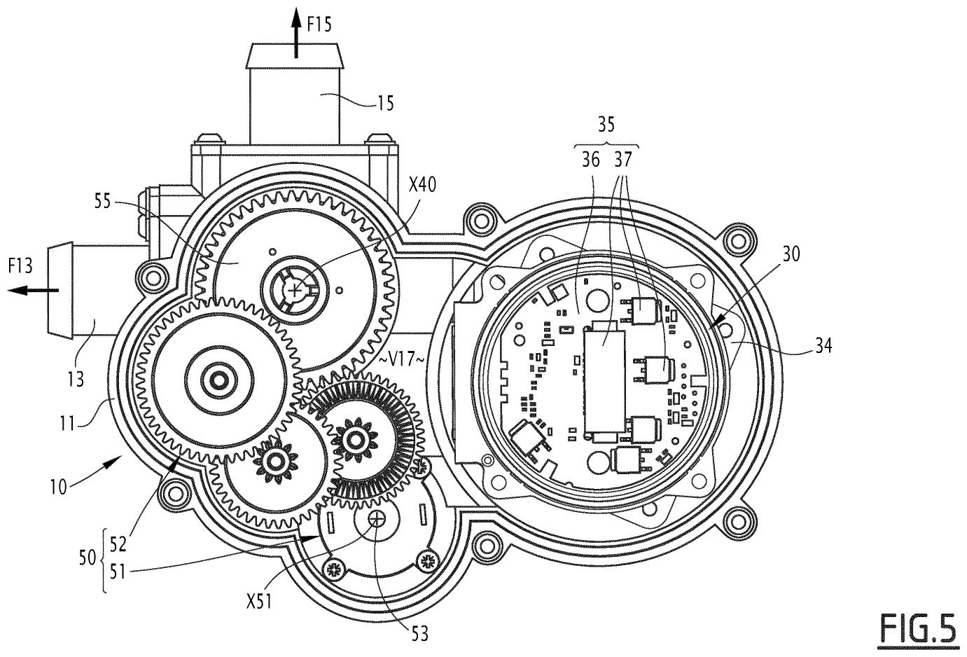

The valve 1 includes a housing 10 through which the fluid to be distributed, in other words to be regulated, by the valve 1 is intended to flow. To this end, as clearly visible in FIGS. 1 to 5, the housing 10 includes a body 11, which defines an internal volume V11 through which the fluid passes through the housing 10, as well as an inlet 12 and outlets, here four in number and respectively referenced 13, 14, 15, and 16. The inlet 12 can communicate with the outlets 13 to 16 through the body 11 via the internal volume V11 of the latter, the effective communication between the inlet 12 and one or more of the outlets 13 to 16 being operated by components of the valve, as detailed below. In service, the fluid enters the internal volume V11 through the inlet 12, as schematically indicated by arrow F12 in the figures, and the fluid exits the internal volume V11 through the outlets 13 to 16, as schematically indicated in the figures by the respective arrows F13, F14, F15, and F16. Before focusing more on the body 11 of the housing 10, it should be noted that, in the embodiment considered in the figures, the housing 10 also includes a cover 17 which, in the assembled state of the valve 1, is fixedly attached to the body 11, as clearly visible in FIGS. 1 and 3. In FIGS. 4 and 5, the cover 17 does not appear since the valve 1 is shown without this cover. This cover 17 and the body 11 define between them a compartment V17 which, in the assembled state of the valve 1, is sealed from the internal volume V11, thus forming an internal region of the housing 10, which is sealed from the fluid circulating through the valve 1 via the internal volume V11. To this end, the cover 17 is attached to the body 11 in a sealed manner by any appropriate means, notably by removable attachment means to facilitate the assembly and maintenance of components of the valve 1 placed inside the compartment V17, such components being detailed below.

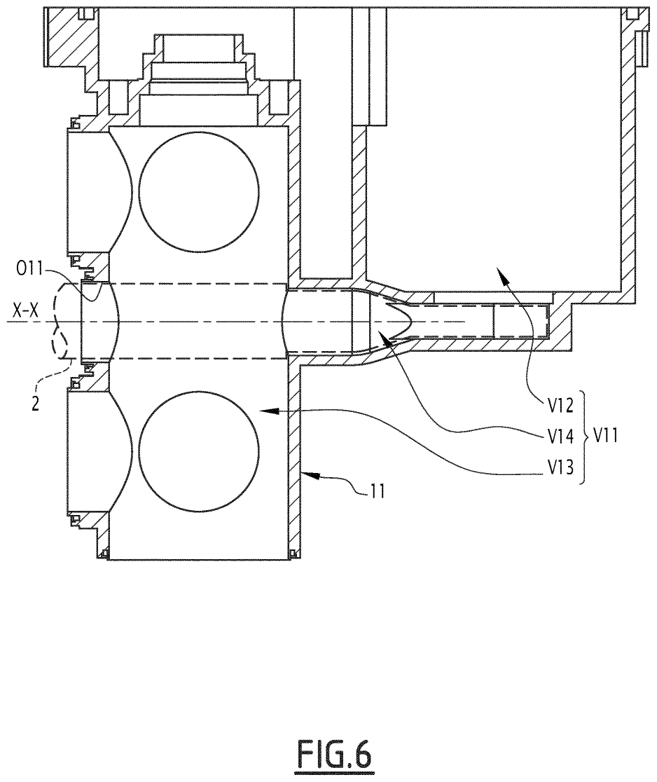

Returning now to the description of the body 11 of the housing 10, it should be noted that this body 11, which is shown alone in FIG. 6, is made in one piece of molded plastic material. The nature of the plastic material constituting the body 11 is not limiting as long as this plastic material is moldable and gives the body 11 sufficient rigidity to fixedly define the internal volume V11. Examples of this plastic material are polyphenylene sulfide, polyphthalamide, and polyamide 6-6. In practice, this plastic material is optionally filled. Moreover, in the embodiment considered in the figures, the inlet 12 is molded with the body 11 while the outlets 13 to 16 are respectively separate pieces from the body 11 and attached to it in a sealed manner; in an unshown variant, it may be otherwise.

In any case, the internal volume V11 of the body 11 is, as clearly visible in FIGS. 3 and 6, distributed between:
a sub-volume V12 wherein the inlet 12 opens,
a sub-volume V13 wherein the outlets 13 to 16 open, and
a passage V14, which directly connects the sub-volumes V12 and V13 and which opens into the sub-volume V13 along a passage axis X-X, or which extends along this passage axis X-X over its entire extent between its ends opening respectively into the sub-volume V12 and into the sub-volume V13.

Moreover, also as clearly visible in FIGS. 3 and 6, the body 11 defines an opening O11 by which the sub-volume V13 is directly connected to the outside of the body 11. The opening 011 is formed by molding-demolding of the body 11, in the sense that the opening O11 results from the use, during the molding of the body 11, of a molding core that extends along the passage axis X-X and around which a part of the plastic material constituting the body 11 is molded, to form the passage V14. Such a molding core is shown in dotted lines in a partial and schematic manner in FIG. 6, being referenced 2. In practice, the molding core 2 is advantageously used in conjunction with a mold (not shown) to manufacture the body 11 by molding. More precisely, to manufacture the body 11 as shown in FIG. 6, it is notably possible to provide that plastic material is introduced, typically injected, into the aforementioned mold to form the body 11 by molding, while the molding core 2 is arranged in this mold extending along the passage axis X-X, so that this plastic material introduced into the mold spreads there to surround the molding core 2 and thus forms both the peripheral wall of the passage V14 and the peripheral wall of the opening O11. To release the body 11 after its molding thus carried out, the aforementioned mold and the molding core 2 are respectively removed: to do this, the molding core 2 is, for example, extracted from the mold before opening the latter, by pulling this molding core 2 along the passage axis X-X to gradually remove it from the passage V14 and, more generally, from the internal volume V11 via the opening O11. In any case, after demolding the body 11, the latter defines, in one piece, the passage V14 and the opening O11, which are aligned with each other along the passage axis X-X, while being separated from each other by the sub-volume V13, as clearly visible in FIG. 6.

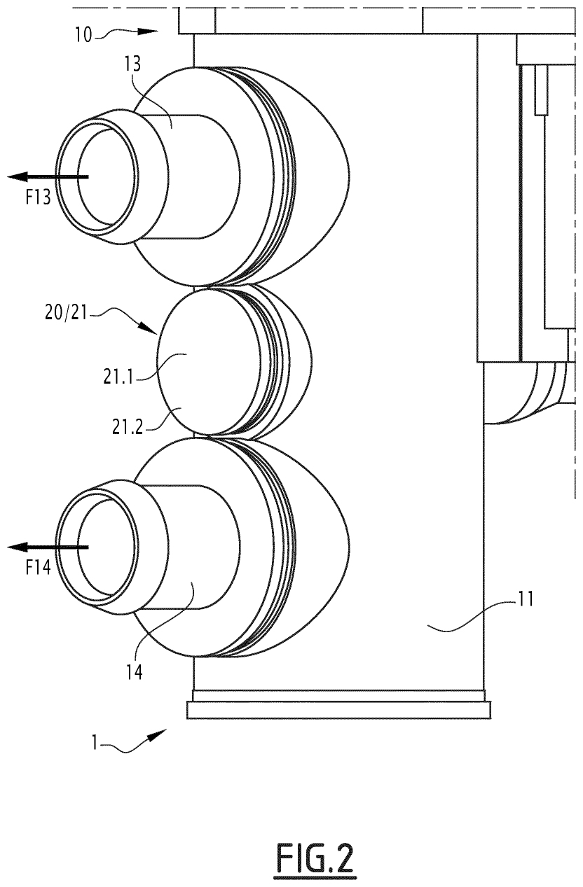

In the assembled state of the valve 1, the opening O11 is not left as it is after demolding the body 11, but is associated with a dedicated member 20 of the valve 1, as clearly visible in FIGS. 2 and 3. In the version of the valve 1 illustrated in FIGS. 1 to 5, this dedicated member 20 consists of a plug 21 which, in the assembled state of the valve 1, seals the opening O11 in a fluid-tight manner with respect to the fluid regulated by the valve 1. In other words, the plug 21 completely closes the opening O11, normally preventing any fluid flow through the opening O11.

The plug 21 is advantageously made in one piece, typically of plastic material, particularly the same plastic material as that constituting the body 11 of the housing 10.

The plug 21 advantageously includes a solid wall 21.1, which, in the assembled state of the valve 1, completely covers the opening O11 and which, on the outer periphery, is extended by a rim 21.2 which, for the purposes of the sealed assembly of the plug 21 to the body 11, is here welded to the body 11, more precisely to the external face of the wall of the latter, surrounding the opening O11. In practice, multiple plastic welding techniques are conceivable, for example vibration and/or ultrasonic welding. The plug 21 here also includes a skirt 21.3, which extends in projection from the solid wall 21.1 and which, in the assembled state of the valve 1, is complementarily received in the opening O11, as clearly visible in FIG. 3.

In practice, other embodiments than the one detailed above are conceivable for the plug 21. Thus, as an unshown variant, rather than being assembled by plastic welding to the body 11, the plug 21 is designed to be assembled to the body 11 with the interposition of a sealing joint, being retained with respect to the opening 11 by any appropriate mechanical means, for example by a force fit or by means of one or more added fastening pieces, such as screws. More generally, the plug 21 is designed to be attached to the body 11 in a sealed manner, the corresponding assembly operation between the plug 21 and the body 11 being carried out after manufacturing the body 11, typically after the molding and demolding operations of the body 11, described above.

Inside the housing 10, the valve 1 includes a pump 30 allowing the aforementioned fluid to be driven through the housing 10 via the internal volume V11. This pump 30 includes a hydraulic part 31 whose embodiment is not limiting as long as this hydraulic part 31 acts on the fluid to drive it through the housing 10 via the internal volume V11. This hydraulic part 31 of the pump 30 is provided with an intake 32, i.e., an orifice through which the fluid to be pumped by the pump 30 flows into this hydraulic part 31 and thus enters the hydraulic part 31, and a discharge 33, i.e., an orifice through which the fluid pumped by the pump 30 flows out of the hydraulic part 31 and thus exits this hydraulic part 31. In the assembled state of the valve 1, the hydraulic part 31 of the pump 30 is carried by the body 11 of the housing 10, being arranged in the sub-volume V12 so that, on the one hand, the intake 32 opens into the inlet 12 of the housing 10 so that all the fluid entering the internal volume V11, via the inlet 12, is directly admitted into the hydraulic part 31, as schematically indicated by arrow F32 in FIG. 4, and, on the other hand, the discharge 33 opens into the passage V14 so that all the fluid discharged by the hydraulic part 31 is directly sent into this passage V14, as schematically indicated by arrow F33 in FIG. 3. In practice, the hydraulic part 31 is assembled to the housing 10 with the interposition of sealing joints, which respectively form ad hoc sealing lines at the intake 32 and the discharge 33. Moreover, in the embodiment considered in the figures, the pump 30 helps to define, together with the body 11 and the cover 17, the compartment V17 and includes for this purpose a flange 34 or similar, through which a casing of the hydraulic part 31 is fixedly attached to the body 11 and on which the cover 17 is mounted in a sealed manner.

In any case, the pump 30 is electric, in the sense that its hydraulic part 31 is driven by an electric motor, integrated into the pump. In practice, multiple embodiments are conceivable for this electric motor and for its integration into the rest of the pump 30, without this aspect of the pump being limiting. In any case, the pump 30 includes an electronic part 35 that controls the hydraulic part 31 by driving the electric motor of the pump 30. In the embodiment considered in the figures, the electronic part 35 includes a printed circuit board 36, which is here fixedly carried by the casing of the hydraulic part 31, and various electronic components 37, which are mounted on the printed circuit board 36 and which are designed to control the electric motor of the pump 30, by sending electrical power and control signals to it. The functional and structural specifics of the electronic part 35 are not limiting, so they will not be further detailed here. In the assembled state of the valve 1, the electronic part 35 is housed inside the compartment V17, as clearly visible in FIGS. 3 and 5.

The valve 1 also includes a shutter 40, which is carried by the housing 10, being arranged in the sub-volume V13 and being movable relative to the housing 10, here in rotation around a shutter axis X40, which advantageously extends transversely, or even perpendicularly to the passage axis X-X. The shutter 40 allows, due to its mobility, here in rotation around the shutter axis X40, to regulate the fluid flow through the housing 10 by controlling the opening and closing of the outlets 13 to 16 of the housing 10. In the assembled state of the valve 1, the shutter 40 cooperates by sealed contact with seats, which are respectively associated with the outlets 13 to 16 and which are carried by the housing 10, so that for each seat, the shutter 40 is provided, depending on its position relative to the housing 10, here around the shutter axis X40, to:
either allow the fluid to pass the seat so that the fluid flows from the sub-volume V13 to the outlet associated with this seat, which amounts to opening this outlet associated with the seat, as schematically illustrated by arrow F40 in FIG. 3 for outlet 13;
or prevent the fluid from passing the seat from the sub-volume V13 to reach the outlet associated with this seat, which amounts to closing this outlet associated with the seat, as illustrated by the barred arrow G40 in FIG. 3 for outlet 14.

Moreover, at least in each of the positions of the shutter 40 relative to the housing 10, here around the shutter axis X40, which control the opening of at least one of the outlets 13 to 16, the shutter 40 allows the fluid to enter the sub-volume V13 from the passage V14, as schematically indicated by arrow F40′ in FIG. 3.

Thus, the shutter 40 allows the fluid entering the internal volume V11 of the housing body 11 to be distributed selectively into one or more of the outlets 13 to 16 of the housing 10.

In the embodiment considered in the figures, the shutter 40 includes a generally tubular body 41, which is centered on the shutter axis X40. On its outer lateral face, the tubular body 41 fixedly carries spherical reliefs 42, which are centered on the shutter axis X40, and which are distributed along this shutter axis to cooperate by shape complementarity with the aforementioned seats, the latter being therefore here provided spherical.

Of course, other embodiments than the one detailed above are conceivable for the shutter 40, such as a vane shutter.

In any case, to control the movement of the shutter 40 and thus control the opening and closing of the outlets 13 to 16 of the housing 10, the valve 1 includes an actuation device 50. This actuation device 50 is electromechanical in the sense that this actuation device is designed to transform electrical energy powering it into a mechanical driving force, applied to the shutter 40 to drive it relative to the housing 10, here in rotation around the shutter axis X40.

In the assembled state of the valve 1, the actuation device 50 is carried by the housing 10, being at least partially housed in the compartment V17. In the embodiment considered in the figures, the actuation device 50 includes an electric motor 51 and a mechanical transmission 52 that connects a motor output 53 of the electric motor 51 to the shutter 40.

The electric motor 51 typically comprises a casing 54 inside which electromechanical components of the electric motor 51 are arranged, which transform electrical energy into driving force, the motor output 53 extending through the casing 54. The casing 54 is fixedly attached to the housing 10, particularly its body 11, by any appropriate means, notably in a dedicated housing of the latter, advantageously belonging to the compartment V17, as schematically indicated in FIG. 1. Here, the motor output 53 rotates around a motor axis X51 relative to the housing 10, the mechanical transmission 52 being designed so that a rotation of the motor output 53 around the motor axis 51 drives the shutter 40, here in rotation around the shutter axis X40.

In the example considered in the figures, the mechanical transmission 52 includes a gear 55 consisting here of several gear wheels meshing successively with each other, a first of these wheels being engaged with the motor output 53 while the last of these gear wheels being engaged with the shutter 40, here with an axial end of its tubular body 41. This gear 55, whose specifics are not limiting, allows the movement transmitted from the motor output 53 to the shutter 40 to be multiplied. Of course, other embodiments than the gear 55 are conceivable for the mechanical transmission 52, notably depending on the kinematics of the motor output 53 and the kinematics of the shutter 40. In any case, as clearly visible in FIGS. 3 to 5, the motor output 53 and the mechanical transmission 52 are advantageously arranged in the compartment V17.

The actuation device 50, particularly its electric motor 51, and the pump 30, particularly its electronic part 35, are electrically connected, inside the compartment V17, to respective connectors or, as here, to a single connector 18, this or these connectors being carried by the housing 10. In the example illustrated in the figures, the single connector 18 is fixedly attached to the cover 17 in a sealed manner, by any appropriate means. In any case, the connector(s) are designed to, outside the valve 1, be each connected to an added harness (not shown) to electrically connect the valve 1 to one or more external units, which are not shown, and which include a power supply source. This power supply source, whose embodiment is not limiting, comprises, for example, a battery that is embedded in the vehicle to the cooling circuit to which the valve 1 belongs. According to one possible embodiment, the aforementioned external units include one or more control and/or supervision units, such as an onboard computer of the vehicle to the cooling circuit to which the valve 1 belongs: the control and/or supervision unit or one of these control and/or supervision units is advantageously designed to control the electric motor 51, by sending ad hoc control electrical signals to it, via the added harness. According to another possible embodiment, the control of the electric motor 51 is operated by an electronic device, which belongs to the valve 1 and which is housed in the compartment V17, being notably integrated into the electrical connection between the connector 18 and the electric motor 51: this electronic device, which is not shown in the figures, can be partially coupled to the electronic part 35 of the pump 30 or be completely separate from the latter, in any case being suitable for sending control and, if necessary, power supply electrical signals to the electric motor 51.

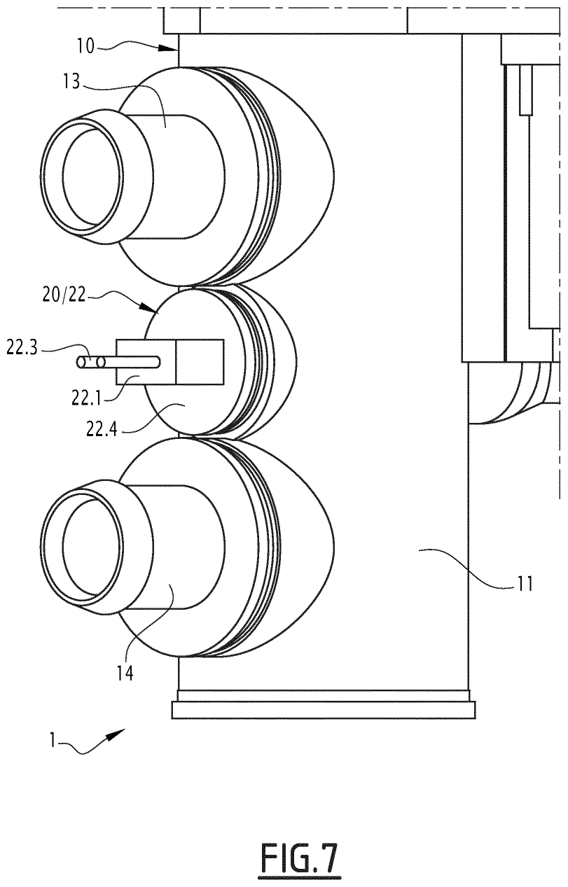

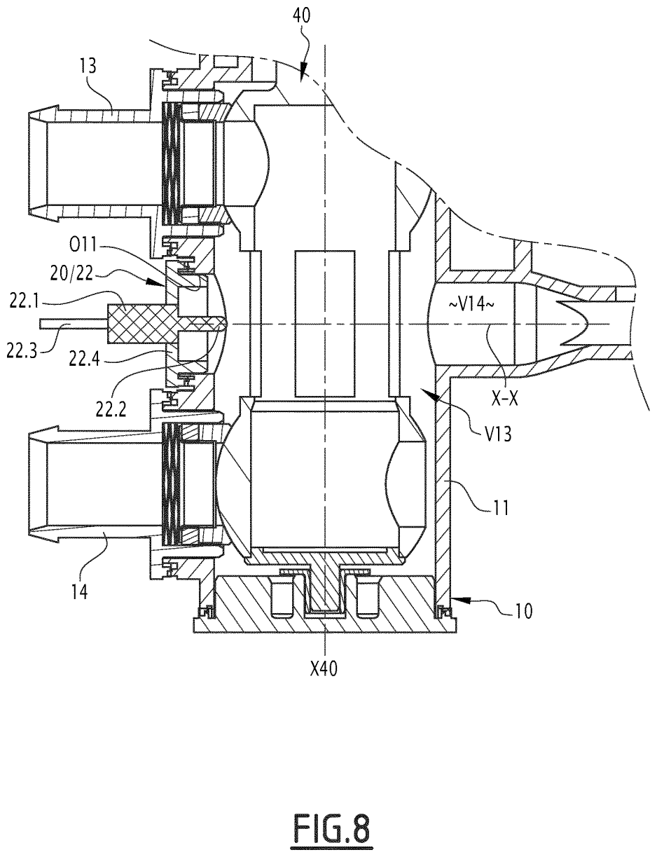

In FIGS. 7 and 8, the valve 1 is shown in a version that differs from its version in FIGS. 1 to 5 in that the dedicated member 20 is not the plug 21, but an instrumented plug 22, i.e., a plug that, while ensuring the fluid-tight sealing of the opening O11, integrates a measuring instrument 22.1 suitable for measuring a physicochemical property of the fluid in the sub-volume V13. It is understood that, compared to the instrumented plug 22, the plug 21 can be qualified as a non-instrumented plug.

The measuring instrument 22.1 is advantageously suitable for measuring the temperature of the fluid in the sub-volume V13. The measuring instrument 22.1 typically includes for this purpose a temperature sensor 22.2 whose specifics are not limiting. Alternatively, the measuring instrument 22.1 can be designed to measure one or more physicochemical properties, other than temperature, of the fluid in the sub-volume V13, for example, viscosity, turbidity, etc.

In any case, the measuring instrument 22.1 is designed to transmit the measurement it performs outside the housing 10. To this end, the measuring instrument 22.1 includes ad hoc transmission means. In the example illustrated in FIGS. 7 and 8, these transmission means include conductive tracks 22.3, through which the measurement signals emitted by the temperature sensor 22.2 are sent outside the housing 10, and which, in the assembled state of the valve 1, are connectable to an ad hoc added harness (not shown). Of course, multiple embodiments are conceivable for the transmission means belonging to the measuring instrument 22.1, possibly embodiments allowing wireless transmission.

The instrumented plug 22 advantageously comprises a support 22.4 that carries the measuring instrument 22.1, possibly being traversed by the latter. The support 22.4 is advantageously made of plastic material, particularly the same plastic material as that constituting the body 11. The instrumented plug 22 is attached to the body 11 in a sealed manner, being assembled to the latter through its support 22.4. This assembly is preferably carried out by plastic welding of the support 22.4 to the body 11, as illustrated in FIGS. 7 and 8, and this is performed according to similar considerations to those mentioned above regarding the welding of the non-instrumented plug 21 to the body 11; however, in an unshown variant, other embodiments are conceivable for this assembly, applying the same considerations as those detailed above regarding the assembly of the non-instrumented plug 21 to the body 11.

More generally, taking into account the explanations given above regarding the non-instrumented plug 21 and the explanations above regarding the instrumented plug 22, it is understood that the two plugs 21 and 22 are each sealing members, each suitable for sealing the opening O11 in a fluid-tight manner with respect to the fluid regulated by the valve 1. Moreover, each of the two plugs 21 and 22 is suitable for forming the dedicated member 20 of the valve 1: the non-instrumented plug 21 is chosen from these two plugs 21 and 22 to obtain the version of the valve 1, illustrated in FIGS. 1 to 5, while the instrumented plug 22 is chosen from the two plugs 21 and 22 to obtain the version of the valve, illustrated in FIGS. 7 and 8.

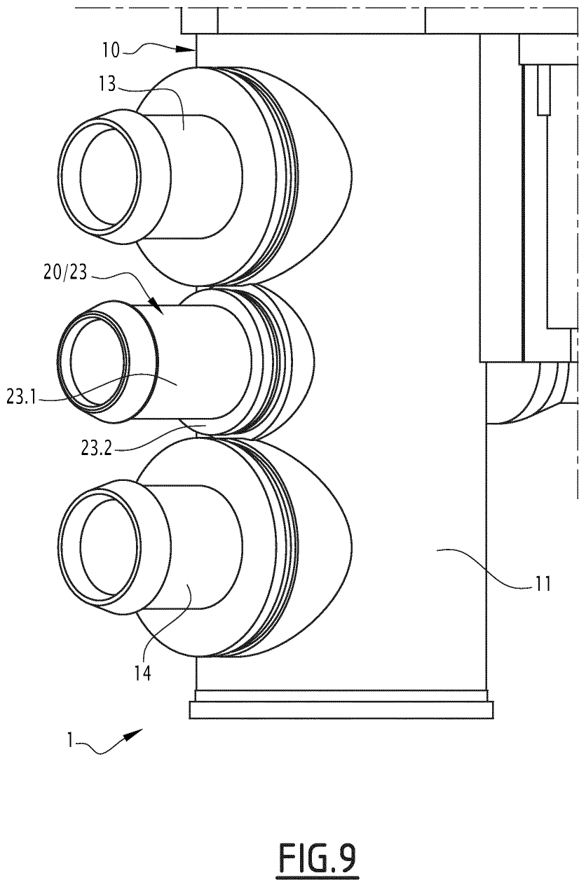

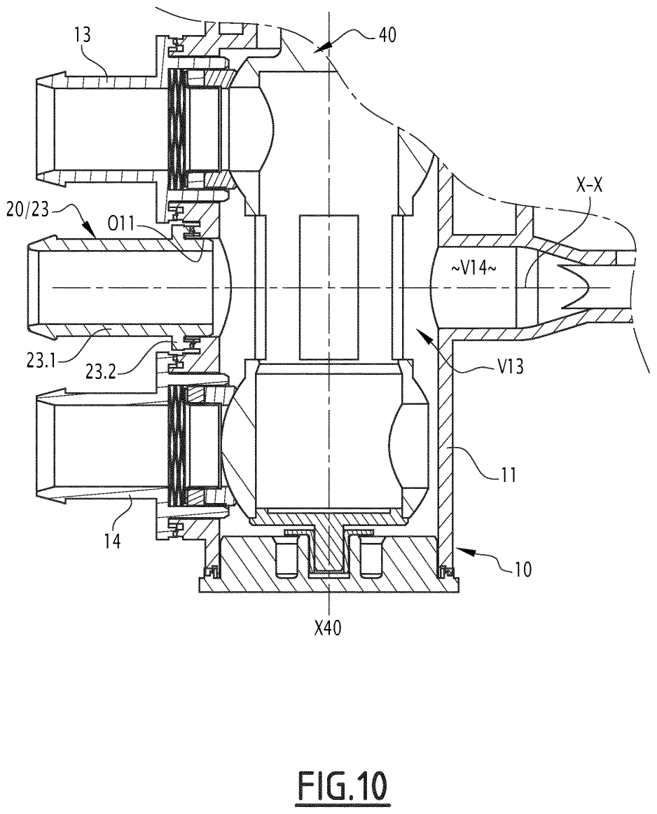

In FIGS. 9 and 10, the valve 1 is shown in a version that differs from its version in FIGS. 1 to 5 and its version in FIGS. 7 and 8, in that the dedicated member 20 is neither the non-instrumented plug 21 nor the instrumented plug 22, but a connecting tube 23, which, in the assembled state of the valve 1, allows the fluid to flow through the opening O11, and which thus forms a corresponding outlet of the housing 10, here in addition to the outlets 13 to 16. In the example considered in the figures, the shutter 40 does not control the opening and closing of the outlet formed by the connecting tube 23, but, in an unshown variant, the shutter 40 includes arrangements allowing the distribution of the fluid selectively into the outlet formed by the connecting tube 23 to be controlled.

By definition, the connecting tube 23 comprises a tubular body 23.1 around which a conduit (not shown), such as a hose, which is externally added to the valve 1, easily connects. The corresponding specifics of the connecting tube 23 are not limiting. In practice, the connecting tube 23 is advantageously made of plastic material, particularly the same plastic material as that constituting the body 11.

In any case, the connecting tube 23 is designed to be attached to the body 11 of the housing 10 in a sealed manner, putting the inside of the connecting tube 23 in free fluid communication with the opening O11 and, thereby, with the sub-volume V13, as clearly visible in FIG. 10. To this end, the connecting tube 23 advantageously includes a rim 23.2, which encircles the outer periphery of the tubular body 23.1, and which is advantageously welded to the body 11, more precisely to the external face of the wall of this body 11, surrounding the opening O11; however, in an unshown variant, rather than being assembled by plastic welding, the connecting tube 23 is assembled to the body 11 with the interposition of a sealing joint, being retained with respect to the opening 11 by any appropriate mechanical means, as previously mentioned in an unshown variant for the assembly of the non-instrumented plug 21 to the body 11.

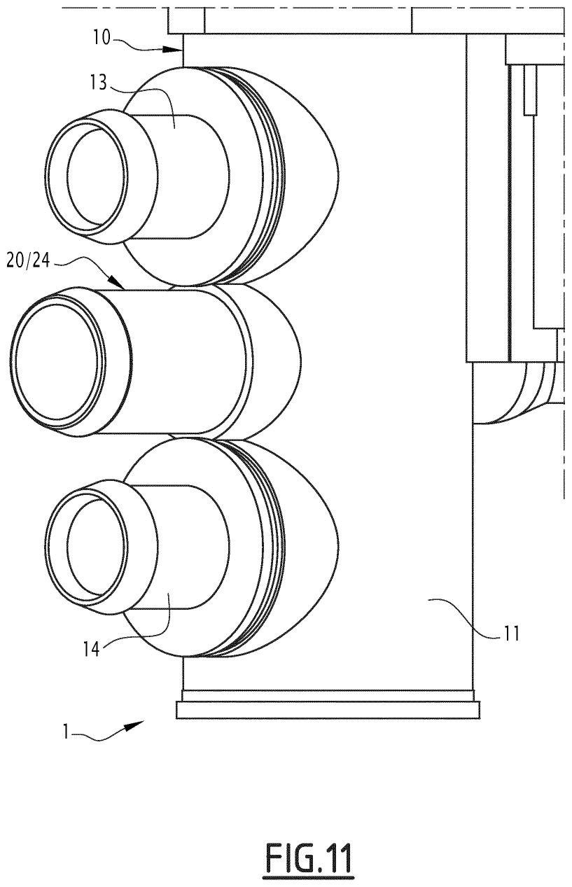

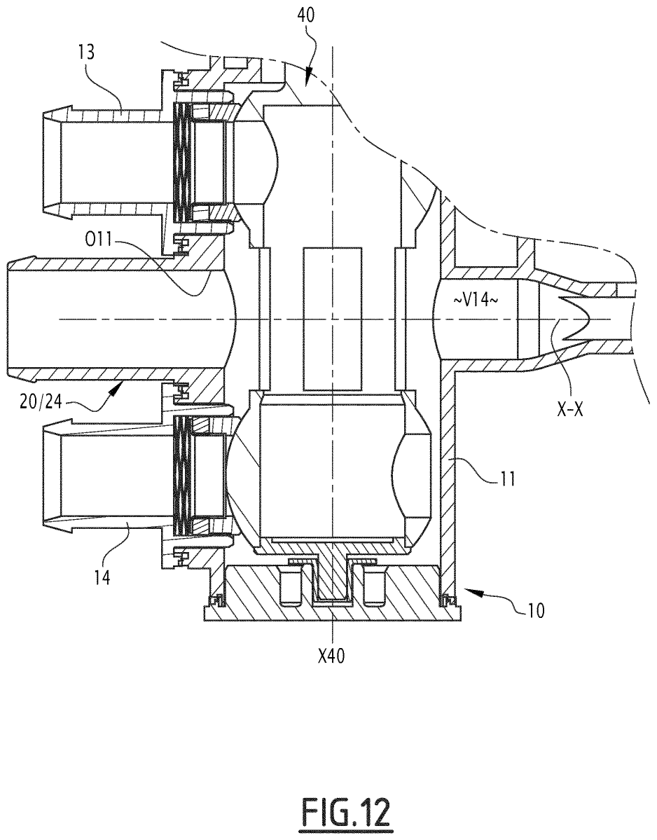

In FIGS. 11 and 12, the valve 1 is shown in a version that differs from its version in FIGS. 1 to 5, its version in FIGS. 7 and 8, and its version in FIGS. 9 and 10, in that the dedicated member 20 is neither the non-instrumented plug 21, nor the instrumented plug 22, nor the connecting tube 23, but a connecting tube 24. Functionally, the connecting tube 24 is similar to the connecting tube 23. Structurally, the connecting tube 24 differs from the connecting tube 23 in that the connecting tube 24 is not attached to the body 11, but is molded with this body 11, as clearly visible in FIG. 12.

Thus, it is understood that the connecting tube 23 and the connecting tube 24 are each flow members, each suitable for allowing fluid to flow through the opening O11, each forming a corresponding outlet of the housing, which here is not intended to be controlled in the open and closed position by the shutter 40 but which, if necessary, can be controlled in the open and closed position by the shutter 40. The outlet of the housing formed by each of these two flow members is here in addition to the outlets 13 to 16, but, in an unshown variant, can replace one of the latter. In any case, each of these two flow members that are the connecting tube 23 and the connecting tube 24 is suitable for forming the dedicated member 20 of the valve 1: the connecting tube 23 is chosen from these two flow members to obtain the version of the valve 1, illustrated in FIGS. 9 and 10, while the connecting tube 24 is chosen from these two flow members to obtain the version of the valve 1, illustrated in FIGS. 11 and 12.

Taking into account all the above, it is understood that the valve 1 is available here in four versions depending on whether its dedicated member 20 is either the non-instrumented plug 21, or the instrumented plug 22, or the connecting tube 23, or the connecting tube 24. In other words, within the valve 1, the dedicated member 20 disposed at the opening O11 is selectively chosen from both the two sealing members that are the non-instrumented plug 21 and the instrumented plug 22 and the two flow members that are the connecting tube 23 and the connecting tube 24. Of course, in a variant, only one of the two aforementioned sealing members and/or only one of the two aforementioned flow members can be provided. Similarly, in a variant, more than two sealing members and/or more than two flow members can be provided, among which the dedicated member 20 is selectively chosen.

Therefore, to manufacture the valve 1, the following three steps are advantageously implemented:
a selection step, wherein the dedicated member 20 of the valve 1 is selected from the aforementioned sealing member(s) and the aforementioned flow member(s), particularly from the non-instrumented plug 21, the instrumented plug 22, the connecting tube 23, and the connecting tube 24,
a first manufacturing step, wherein the body 11 of the housing 10 is manufactured by molding-demolding, as explained above in connection with the description of the body 11, and
a second manufacturing step, wherein the dedicated member 20 selected in the selection step is formed at the opening O11 of the body 11.

In practice, the three steps above can follow one another in different ways, provided that the selection step necessarily precedes the second manufacturing step. Thus, when the dedicated member 20 selected in the selection step is to be attached to the body 11, notably when the dedicated member thus selected is either the non-instrumented plug 21, or the instrumented plug 22, or the connecting tube 23, the second manufacturing step is implemented after the first manufacturing step and this second manufacturing step includes assembling the dedicated member thus selected to the body 11 in a sealed manner. In contrast, when the dedicated member 20 selected in the selection step is the connecting tube 24 or, more generally, a flow member to be integrated in one piece with the body 11 of the housing 10, the second manufacturing step is implemented simultaneously with the first manufacturing step and includes molding this flow member together with the body 11.

Of course, in addition to the three steps above, the manufacturing process of the valve 1 includes one or more assembly steps, during which all the components of the valve 1, other than the body 11 and the dedicated member 20, are assembled together and with the body 11 to result in the complete valve 1.

Finally, various arrangements and variants to the valve 1 and its manufacturing process, described so far, are also conceivable:
the number of outlets of the housing 10 is not necessarily equal to four or five, as considered in the figures, but can, for example, be limited to two or three or be equal to a number greater than five; and/or
the relative arrangement between the shutter axis X40 and the motor axis X51 is not limited to what is considered in the figures on which these two axes are parallel, the motor axis X51 can thus extend transversely to the shutter axis X40, notably perpendicularly or orthogonally to this shutter axis X40.

This valve (1) includes a housing (10), which includes a body (11) made of molded plastic and defining an internal volume (V11) connected to the outside of the housing by an inlet and outlets. An electric pump (30), arranged in a first sub-volume, is provided with an intake opening into the inlet and a discharge (33) opening into a passage (V14) connecting the first sub-volume to a second sub-volume (V13) by opening into it along a passage axis (X-X). A shutter (40) is arranged in the second sub-volume in a manner that can be moved by an electromechanical actuating device to control the opening and closing of the outlets. The body defines an opening (O11), through which the second sub-volume is directly connected to the outside of the body, which is formed by molding-demolding the body in axial alignment with the passage, and at which a dedicated member (20) is selectively chosen from one or more sealing members (21), each suitable for sealing the opening in a fluid-tight manner, and one or more flow members, each suitable for allowing fluid to flow through the opening, forming one of the outlets.

1. A fluid-dispensing motorized valve 1, including:
a housing that includes a body made of molded plastic material and defining an internal volume through which a fluid passes through the housing, this internal volume being connected to an outside of the housing by an inlet of the housing, through which the fluid enters the internal volume, and by at least two outlets , of the housing, through which the fluid exits the internal volume,
an electric pump, which is arranged in a first sub-volume of the internal volume, and which is provided with an intake, opening into the inlet of the housing, and a discharge, opening into a passage of the internal volume, this passage connecting the first sub-volume to a second sub-volume of the internal volume by opening into this second sub-volume along a passage axis,
a shutter, which is arranged in the second sub-volume in a movable manner relative to the body of the housing to control the opening and closing of all or part of the at least two outlets of the housing, and
an electromechanical actuation device, which is carried by the housing, and which is suitable for driving the shutter in movement relative to the body of the housing, wherein the body 11 of the housing 10 defines an opening:
by which the second sub-volume V13 is directly connected to the outside of the body,
which is formed by molding-demolding of the housing body, being aligned with the passage along the passage axis, and
at which a dedicated member of the valve is disposed, selectively chosen from one or more sealing members each suitable for sealing the opening in a fluid-tight manner, and one or more flow members each suitable for allowing fluid to flow through the opening, forming one of said at least two outlets of the housing.

2. The valve according to claim 1, wherein the dedicated member is attached to the body of the housing in a sealed manner.

3. The valve according to claim 2, wherein one or more of the sealing members is a non-instrumented plug.

4. The valve according to one claim 2, wherein one or more of the sealing members integrates a measuring instrument suitable for measuring a physicochemical property of the fluid in the second sub-volume, such as temperature, and to transmit the corresponding measurement outside the housing.

5. The valve according to claim 2, wherein one or more of the flow members is a connecting tube.

6. The valve according to claim 2, wherein the dedicated member 20 is assembled to the body 11 of the housing 10 by welding a plastic part of the dedicated member to the body.

7. The valve according to claim 2, wherein the dedicated member is assembled to the body of the housing with the an interposition of a sealing joint.

8. The valve according to claim 1, wherein one or more of the flow members is a connecting tube , which is molded with the body of the housing.

9. A method for manufacturing a valve according to any one of the preceding claims, this method comprising:
a selection step, wherein the dedicated member of the valve,
a first manufacturing step, wherein plastic material is introduced into a mold to form the body of the housing by molding and, in the mold, surrounds a molding core extending along the passage axis to form the passage and the opening, then the mold and the molding core are removed to release the housing body, and
a second manufacturing step, wherein the dedicated member selected in the selection step is formed at the opening.

10. The method according to claim 9, wherein, when the dedicated member 20 selected in the selection step is to be attached to the body of the housing, the second manufacturing step is implemented after the first manufacturing step and includes assembling the dedicated member to the housing body in a sealed manner.

11. The method according to claim 9, wherein, when the dedicated member selected in the selection step is one or more of the flow members which is to be integrated in one piece with the body of the housing, the second manufacturing step is implemented simultaneously with the first manufacturing step and includes molding this flow member together with the housing body.

12. The valve according to claim 4, wherein a physiochemical property of the fluid is temperature.
